(19) United States
(12) Patent Application Publication
(10) Pub. No.: US 2018/0048054 A1
(43) Pub. Date: Feb. 15, 2018

(54) MOBILE TERMINAL AND METHOD FOR BALANCING RADIATION

(71) Applicants: NANNING FUGUI PRECISION INDUSTRIAL CO., LTD., Nanning (CN); HON HAI PRECISION INDUSTRY CO., LTD., New Taipei (TW)

(72) Inventor: AI-NING SONG, Shenzhen (CN)

(21) Appl. No.: 15/272,353

(22) Filed: Sep. 21, 2016

(30) Foreign Application Priority Data
Aug. 12, 2016 (CN) 201610664730.0

(51) Int. Cl. H01Q 1/24; H01Q 3/24

(52) U.S. Cl. CPC H01Q 1/245; H01Q 1/243; H01Q 3/24

(57) ABSTRACT

A mobile terminal with multiple antennas which can balance the directional output of radiation includes a first antenna, a second antenna, a control unit, a switch unit, and a baseband processing unit. The baseband processing unit determines radiation power of signals to be transmitted by the first antenna or the second antenna. The control unit obtains the radiation power from the baseband processing unit. When the radiation power is greater than a predetermined power, the control unit outputs a switch signal. When the switch unit receives the switch signal, a periodic switching between the first antenna and the second antenna for transmission purposes makes the first antenna and the second antenna periodically transmit signals to balance the output radiation between antennas.

### CROSS-REFERENCE TO RELATED APPLICATIONS

This application claims priority to Chinese Patent Application No. 201610664730.0 filed on Aug. 12, 2016, the contents of which are incorporated by reference herein.

### FIELD

The subject matter herein generally relates to mobile communication devices, and particularly to a mobile terminal and a method for balancing radiation.

### BACKGROUND

Radio frequency energy or electromagnetic energy can be absorbed by a human. SAR (Specific Absorption Rate) is a measurement of the amount of radio frequency energy (radiation) absorbed by the body when using a mobile terminal such as a telephone. The radiation intensity of the mobile terminals in each direction (up and down, to the left and to the right, from front and back) is different, thus each direction of SAR is different. Most mobile terminals sacrifice wireless performance to reduce SAR.

### BRIEF DESCRIPTION OF THE DRAWINGS

Implementations of the present technology will now be described, by way of example only, with reference to the attached figures.

FIG. 1 is a block diagram of an embodiment of a mobile terminal;

FIG. 2 is a block diagram of an embodiment of a mobile terminal;

FIG. 3 is a cause-and-effect diagram of an embodiment of the mobile terminal.

FIG. 4 is a flowchart showing a method for redistributing radiation of an embodiment of the mobile terminal.

FIG. 5 is a flowchart showing a method for balancing radiation of an embodiment of the mobile terminal.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean at least one.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

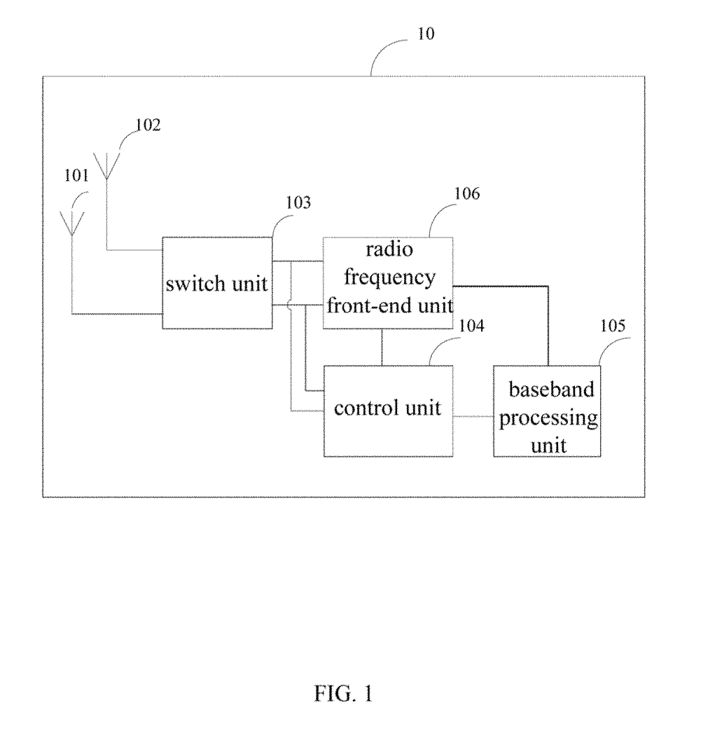

FIG. 1 illustrates a first embodiment of a mobile terminal 10. In at least one embodiment, the mobile terminal 10 can be a mobile phone, an intercom or other communication mobile terminal. In at least one embodiment, the mobile terminal 10 comprises a first antenna 101, a second antenna 102, a switch unit 103, a control unit 104, and a baseband processing unit 105. The first antenna 101 can be operated as a transmitting antenna or a receiving antenna. When the first antenna 101 operates as the transmitting antenna, the first antenna 101 transmits a to be transmitted (TBT) signal, and when the first antenna 101 operates as the receiving antenna, the first antenna 101 receives an external signal. Similarly, the second antenna 102 can be operated as a transmitting antenna or a receiving antenna. When the second antenna 102 operates as the transmitting antenna, the second antenna 102 transmits a TBT signal, and when the second antenna 102 operates as the receiving antenna, the second antenna 102 receives an external signal.

In at least one embodiment, field patterns of the first antenna 101 and the second antenna 102 are oriented in different directions, so that the strongest radiation direction of the first antenna 101 is different from that of the second antenna 102. Thus the strongest SAR direction of the first antenna 101 is different from that of the second antenna 102.

In at least one embodiment, when the first antenna 101 is operated as the transmitting antenna, the second antenna 102 is operated as the receiving antenna. Similarly, when the second antenna 102 is operated as the transmitting antenna, the first antenna 101 is operated as the receiving antenna. In other embodiments, both the first antenna 101 and the second antenna 102 can be operated as the transmitting antenna simultaneously. Similarly, both the first antenna 101 and the second antenna 102 can be operated as the receiving antenna simultaneously.

The baseband processing unit 105 generates the TBT signal transmitted by the mobile terminal 10 and determines the TBT signal radiation power. The baseband processing unit 105 also processes an external signal received by the first antenna 101 or the second antenna 102.

The control unit 104 is coupled to the baseband processing unit 105. The control unit 104 obtains the TBT signal radiation power from the baseband processing unit 105 and determines whether the TBT signal radiation power is greater than a predetermined power. When the TBT signal radiation power is greater than the predetermined power, the control unit outputs a switch signal.

The switch unit 103 is coupled to the first antenna 101, the second antenna 102, and the control unit 104. When the switch unit 103 receives the switch signal from the control unit 104, a periodic switching between the first antenna 101 and the second antenna 102 takes place. The periodic switching makes the first antenna 101 and the second antenna 102 periodically couple to the baseband processing unit 105, in order to transmit the TBT signal. In the embodiment, the first antenna 101 is operated as the transmitting antenna on an initial state. In other embodiments, the second antenna 102 can be operated as the transmitting antenna on an initial state.

In at least one embodiment, the control unit 104 calculates a first duration time of the first antenna 101 as the transmitting antenna and calculates a second duration time of the second antenna 102 as the transmitting antenna in relation to transmissions. When the first duration time is greater than a first predetermined time, the control unit 104 controls the switch unit 103 to select the second antenna 102 to transmit the TBT signal. When the second duration time is greater than a second predetermined time, the control unit 104 controls the switch unit to select the first antenna to transmit the TBT signal.

Specific Absorption Rate (SAR) is the measure of amount of radiation or electromagnetic energy absorbed by body when exposed to mobile terminals like mobile phone. The units of SAR are watts per kilogram (W/kg). Currently, the Federal Communication Commission in the United States requires cellular telephones to have a SAR level of about 1.6 watts per kilogram of body tissue (1.6 W/kg) or less. Other countries have similar limits, for example, the European limit for SAR is about 2 W/kg. In at least one embodiment, the period of the switching between the first antenna 101 and the second antenna 102 is 6 minutes. The first duration time of the first antenna 101 as the transmitting antenna to transmit TBT signal and the second duration time of the second antenna 102 as the transmitting antenna are determined by the test value of SAR for the first antenna 101 and the second antenna 102 in a period.

In an exemplary embodiment, the first duration time of the first antenna 101 as the transmitting antenna is set to 2 minutes and the second duration time of the second antenna 102 is set to 4 minutes. The value of SAR in a period of 6 minutes is in line with the European standard. Thus the first predetermined time is set to 2 minutes and the second predetermined time is set to 4 minutes. In another exemplary embodiment, the first predetermined time can be set to 1 minute and the second predetermined time can be set to 2 minutes. When the first duration time of the first antenna 101 as the transmitting antenna is greater than 1 minute, the control unit 104 controls the switch unit 103 to select the second antenna 102 as the transmitting antenna. When the second duration time of the second antenna 102 as the transmitting antenna is greater than 2 minutes, the control unit 104 controls the switch unit 103 to select the first antenna 101 as the transmitting antenna. Once again, when the first duration time of the first antenna 101 as the transmitting antenna is greater than 1 minute, the control unit 104 controls the switch unit 103 to select the second antenna 102 as the transmitting antenna, and when the second duration time of the second antenna 102 as the transmitting antenna is greater than 2 minutes, the control unit 104 controls the switch unit 103 to select the first antenna 101 as the transmitting antenna. A switching period is completed. In other embodiments, the first predetermined time also can be set to 30 seconds and the second predetermined time also can be set to 1 minute, as long as the first antenna 101 is operated as the transmitting antenna for 2 minutes overall and the second antenna 102 is operated as the transmitting antenna for 4 minutes overall.

In at least one embodiment, the control unit 104 obtains the TBT signal radiation power from the baseband processing unit again when a switching period between the first antenna 101 and the second antenna 102 is completed. When the radiation power obtained by the control unit 104 is less than the predetermined power, the control unit 104 does not output a switch signal and continues to obtain the TBT signal radiation power from the baseband processing unit 105. In other embodiments, the control unit 104 further calculates the switching periods of the switch unit 103. The control unit 104 obtains the TBT signal radiation power from the baseband processing unit again when the switching unit periodically switches between the first antenna and the second antenna for predetermined periods. The predetermined periods can be set to 2 periods, 3 periods, and so on, which is set by the control unit 104.

In at least one embodiment, the mobile terminal 10 further comprises a radio frequency front-end unit 106. The radio frequency front-end unit 106 is coupled to the switch unit 103 and the baseband processing unit 105. The radio frequency front-end unit 106 comprises a transmit end and a receive end. The antenna which is coupled to the transmit end by the switch unit 103 is operated as the transmitting antenna. The TBT signal is amplified and filtered by the radio frequency front-end unit 106, and is transmitted by the transmitting antenna. The antenna which is coupled to the receive end by the switch unit 103 is operated as the receiving antenna to receive an external signal. The external signal is filtered by the radio frequency front-end unit 106 and is sent to the baseband processing unit 105.

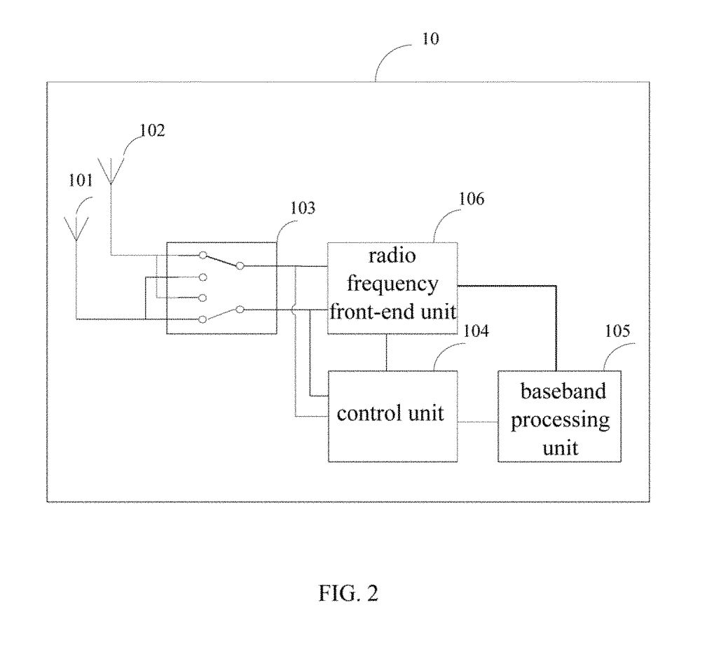

FIG. 2 illustrates a second embodiment of a mobile terminal 10. In at least one embodiment, the mobile terminal 10 comprises a first antenna 101, a second antenna 102, a switch unit 103, a control unit 104, and a baseband processing unit 105. The first antenna 101, the second antenna 102, the control unit 104, and a baseband processing unit 105 are similar to those in the first embodiment as described above.

In the embodiment, the switch unit 103 can be a double pole double throw switch. The double pole double throw switch comprises a first control end, a second control end, a first end, a second end, a third end, and a fourth end. The first control end is coupled to the transmit end and the control unit 104, and the second control end is coupled to the receive end and the control unit 104. The common end of the first end and the second end is coupled to the first antenna 101, and the common end of the third end and the fourth end is coupled to the second antenna 102. When the first control end is coupled to the first end, the first antenna 101 is coupled to the transmit end to operate as the transmitting antenna. When the first control end is coupled to the second end, the first antenna 101 is coupled to the receive end to operate as the receiving antenna. Similarly, when the second control end is coupled to the third end, the second antenna 102 is coupled to the transmit end to operate as the transmitting antenna. When the second control end is coupled to the fourth end, the second antenna 102 is coupled to the receive end to operate as the receiving antenna. In other embodiments, the switch unit 103 can be other switching modules that achieve the same switching function.

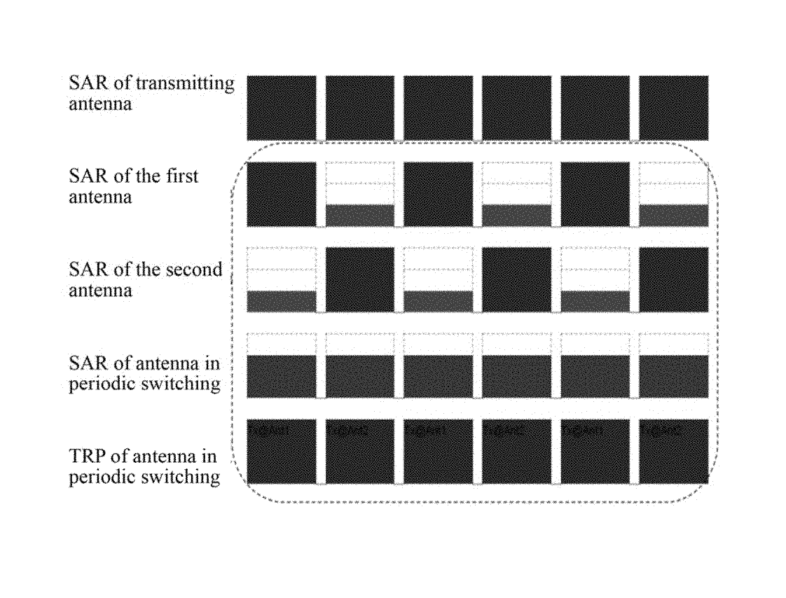

FIG. 3 illustrates a visual representation of cause-and-effect in relation to transmissions of the mobile terminal 10. When the first antenna 101 or the second antenna 102 is constantly operated as the transmitting antenna, the radiation power of the mobile terminal 10 must be reduced, or the SAR will exceed the standard value. In at least one embodiment, when the radiation power is greater than the predetermined power, a periodic switching between the first antenna 101 and the second antenna 102 makes the first antenna 101 and the second antenna 102 periodically couple to the baseband processing unit 105, in order to transmit the TBT signal.

In the embodiment, the first antenna 101 is operated as the transmitting antenna for half a period, and the second antenna 102 is operated as the receiving antenna for half a period. The first predetermined time is set to 1 minute and the second predetermined time is set to 1 minute. The first antenna 101 and the second antenna 102 are operated as the transmitting antenna alternately in a period, to balance the radiation of the first antenna 101 and the second antenna, to balance radiation in each direction. Thus the value of SAR in a period of 6 minutes can be in line with the European standard without sacrificing wireless performance. In other embodiments, the first antenna 101 can be operated as the transmitting antenna for one-third period, and the second antenna 102 can be operated as the receiving antenna for two-third period, which is determined by the test value of SAR for the first antenna 101 and the second antenna 102 in a period.

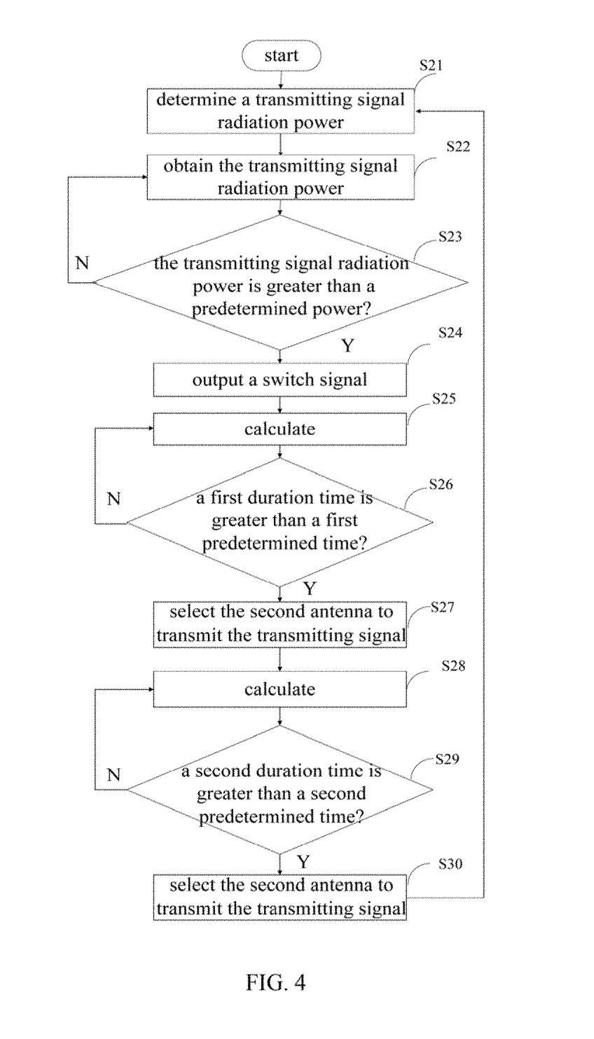

FIG. 4 illustrates a flowchart showing a method for balancing radiation applied in the mobile terminal 10. The mobile terminal 10 comprises the first antenna 101, the second antenna 102, the switch unit 103, the control unit 104, the baseband processing unit 105, and the radio frequency front-end unit 106 with the transmit end and the receive end. The method for balancing radiation comprises the following steps:

Step S21, the baseband processing unit 105 generates and determines the TBT signal radiation power of the transmitting antenna.

Step S22, the control unit 104 obtains the TBT signal radiation power of the transmitting antenna from the baseband processing unit 105.

Step S23, the control unit 104 determines whether the TBT signal radiation power of the transmitting antenna is greater than the predetermined power. If yes, the procedure goes to step S24, otherwise, the procedure goes to step S22. In at least one embodiment, both the first antenna 101 and the second antenna 102 can be operated as the transmitting antenna. The antenna which is coupled to the transmit end is operated as the transmitting antenna to transmit the TBT signal. The antenna which is coupled to the receive end is operated as the receiving antenna to receive the external signal.

Step S24, the control unit 104 outputs the switch signal. In at least one embodiment, the first antenna 101 is operated as the transmitting antenna on the initial state of the periodic switching. In other embodiments, the second antenna 102 can be operated as the transmitting antenna on the initial state of the periodic switching.

Step S25, the control unit 104 calculates the first duration time of the first antenna 101 transmitting the TBT signal.

Step S26, the control unit 104 determines whether the first duration time is greater than the first predetermined time. If yes, the procedure goes to step S27, otherwise, the procedure goes to step S25.

Step S27, the switch unit 103 selects the second antenna 102 to transmit the TBT signal.

Step S28, the control unit 104 calculates the second duration time of the second antenna 102 transmitting the TBT signal.

Step S29, the control unit 104 determines whether the second duration time is greater than the second predetermined time. If yes, the procedure goes to step S30, otherwise, the procedure goes to step S28.

Step S30, the switch unit 103 selects the first antenna 101 to transmit the TBT signal, the procedure goes to step S21. In the embodiment, one switching between the first antenna 101 and the second antenna 102 is described in a period for the sake of brevity. In other embodiment, multiple switching between the first antenna 101 and the second antenna 102 can be performed in a period, which set by the control unit 104.

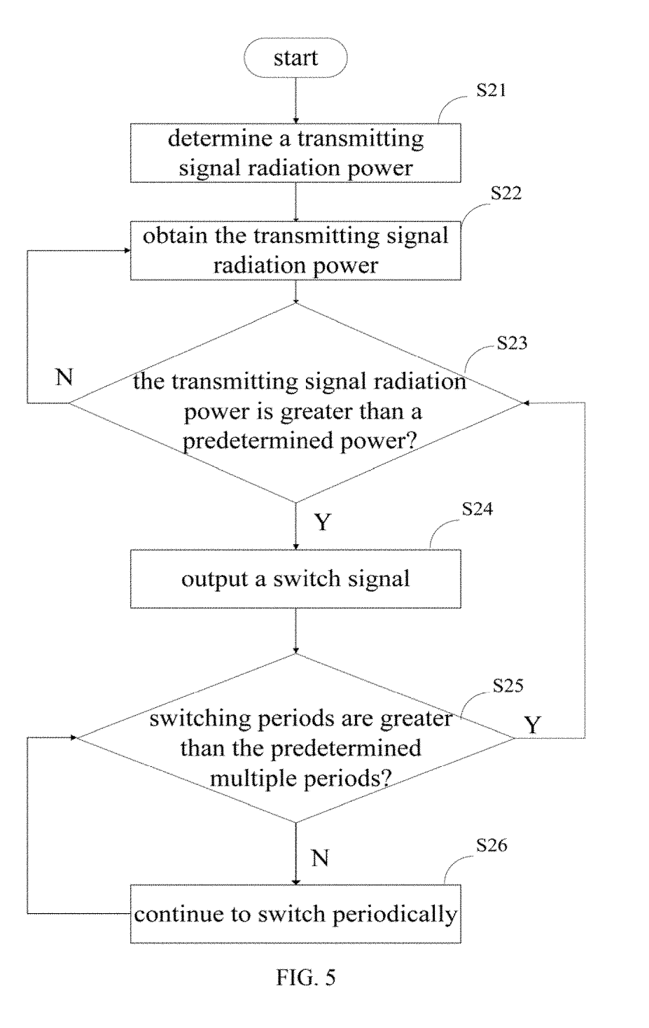

FIG. 5 illustrates a flowchart showing a method for balancing radiation applied in the mobile terminal 10 of a second embodiment. The mobile terminal 10 comprises the first antenna 101, the second antenna 102, the switch unit 103, the control unit 104, the baseband processing unit 105 and the radio frequency front-end unit 106 with the transmit end and the receive end. The method for balancing radiation comprises the following steps:

Step S21, the baseband processing unit 105 generates and determines the TBT signal radiation power of the transmitting antenna.

Step S22, the control unit 104 obtains the TBT signal radiation power of the transmitting antenna from the baseband processing unit 105.

Step S23, the control unit 104 determines whether the TBT signal radiation power of the transmitting antenna is greater than the predetermined power. If yes, the procedure goes to step S24, otherwise, the procedure goes to step S22. In at least one embodiment, both the first antenna 101 and the second antenna 102 can be operated as the transmitting antenna. The antenna which is coupled to the transmit end is operated as the transmitting antenna to transmit the TBT signal. The antenna which is coupled to the receive end is operated as the receiving antenna to receive the external signal.

Step S24, the control unit 104 outputs the switch signal. In at least one embodiment, the first antenna 101 is operated as the transmitting antenna on the initial state of the periodic switching. In other embodiments, the second antenna 102 can be operated as the transmitting antenna on the initial state of the periodic switching.

Step S25, the control unit 104 determines whether the switching periods are greater than the predetermined periods. If yes, the procedure goes to step S23, otherwise, the procedure goes to step S26.

Step S26, continue to switch periodically. In the embodiment, each of the predetermined periods lasts for 6 minutes.

In the mobile terminal 10 and the method for balancing radiation, the control unit obtains the TBT signal radiation power of the transmitting antenna from the baseband processing unit 105. When the TBT signal radiation power is greater than the predetermined power, a periodic switching between the first antenna 101 and the second antenna 102 makes the first antenna 101 and the second antenna 102 operate as the transmitting antenna alternately in a period. The periodic switching between the first antenna 101 and the second antenna 102 balances the radiation of the first antenna 101 and the second antenna 102, resulting in the radiation of each direction being balanced. Thus the value of SAR in a period of 6 minutes in line with the European standard without sacrificing wireless performance.

Depending on the embodiments, certain of the steps described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

Many details are often found in the art such as the other features of mobile terminal. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A mobile terminal comprising:
a first antenna;
a second antenna;
a baseband processing unit configured to generate a to be transmitted (TBT) signal and determine a TBT signal radiation power;
a control unit coupled to the baseband processing unit, configured to obtain the TBT signal radiation power and determines whether the TBT signal radiation power is greater than a predetermined power; wherein when the TBT signal radiation power is greater than the predetermined power, the control unit outputs a switch signal;
a switch unit coupled to the first antenna, the second antenna and the control unit; wherein when the switch unit receives the switch signal from the control unit, and a periodic switching between the first antenna and the second antenna makes the first antenna and the second antenna periodically to couple to the baseband processing unit, to transmit the TBT signal.

2. The mobile terminal of claim 1, wherein the control unit is further configured to calculate a first duration time of the first antenna transmitting the TBT signal and calculate a second duration time of the second antenna transmitting the TBT signal; wherein when the first duration time is greater than a first predetermined time, the control unit controls the switch unit to select the second antenna to transmit the TBT signal; when the second duration time is greater than a second predetermined time, the control unit controls the switch unit to select the first antenna to transmit the TBT signal.

3. The mobile terminal of claim 2, wherein when the switching unit periodically switches between the first antenna and the second antenna for predetermined periods, the control unit obtains the TBT signal radiation power again; and when the TBT signal radiation power is less than the predetermined power, the control unit does not output the switch signal and continue to obtain the TBT signal radiation power.

4. The mobile terminal of claim 1, further comprising a radio frequency front-end unit, wherein the radio frequency front-end unit comprises a transmit end and a receive end, an antenna coupled to the transmit end is a transmit antenna and an antenna coupled to the receive end is a receive antenna.

5. The mobile terminal of claim 1, wherein the switch unit is a double pole double throw switch.

6. The mobile terminal of claim 1, wherein field patterns of the first antenna and the second antenna are oriented in different directions.

7. The mobile terminal of claim 3, wherein each of the predetermined periods lasts for 6 minutes.

8. A method for balancing radiation, which is applied to a mobile terminal with a first antenna and a second antenna, the method comprising:
a. generating a to be transmitted (TBT) signal and determining a TBT signal radiation power;
b. obtaining, and determining whether the TBT signal radiation power is greater than a predetermined power; and
c. switching between the first antenna and the second antenna to make the first antenna and the second antenna periodically to transmit the TBT signal when the TBT signal radiation power is greater than the predetermined power.

9. The method of claim 8, further comprising:
calculating a first duration time of the first antenna transmitting the TBT signal, wherein when the first duration time is greater than a first predetermined time, the second antenna is select to transmit the TBT signal; and
calculating a second duration time of the second antenna transmitting the TBT signal; wherein when the second duration time is greater than a second predetermined time, the first antenna is select to transmit the TBT signal.

10. The method of claim 8, further comprising:
obtaining the TBT signal radiation power again when a predetermined periods switching between the first antenna and the second antenna.

11. The method of claim 8, wherein field patterns of the first antenna and the second antenna are oriented in different directions.

12. The method of claim 10, wherein each of the predetermined periods lasts for 6 minutes.
